(19) United States
(12) Patent Application Publication
(10) Pub. No.: US 2026/0030137 A1
(43) Pub. Date: Jan. 29, 2026

(54) PARALLELIZED EXECUTION OF OPERATIONS IN DYNAMICALLY DEFINED PACKAGES

(71) Applicant: SAP SE, Walldorf (DE)

(72) Inventors: Bjoern Jueliger, Heidelberg (DE); Axel Jebens, Wiesloch (DE); Andreas Schoknecht, Linkenheim-Hochstetten (DE); Hartmut Willy, Wiesloch (DE); Ralf Schroth, Bad Schönborn (DE)

(21) Appl. No.: 18/781,215

(22) Filed: Jul. 23, 2024

(51) Int. Cl. G06F 11/36; G06F 8/77; G06F 9/52

(52) U.S. Cl. CPC G06F 11/3612; G06F 8/77; G06F 9/52

(57) ABSTRACT

The present disclosure relates to computer-implemented methods, software, and systems for dynamic execution of operations over multiple parallel threads. An execution of objects through packages using parallel threads is triggered at an execution engine. Each package of a first set of packages defined for the execution includes a pre-defined number of objects. It is determined to adjust the pre-defined number of objects per package as defined for the first set of packages at the parallel threads to an adjusted number of objects per package to define a second set of packages. The execution at the parallel threads can be adjusted to execute the second set of packages through the execution engine, wherein each package of the second set of packages includes the adjusted number of objects.

### TECHNICAL FIELD

The present disclosure relates to computer-implemented methods, software, and systems for data processing.

### BACKGROUND

Software development lifecycle can be associated with execution of quality checks of the source code of given projects defined for products. Software products can be defined with version, where new version replace or modify previously defined versions. The execution of operations related to phases of the lifecycle of software products can be resource consuming. Operations can be executed to rely on parallel processing.

### SUMMARY

Implementations of the present disclosure are generally directed to computer-implemented method for dynamic execution of operations over multiple parallel threads.

In a first general aspect, this specification can be embodied in one or more methods (and also one or more non-transitory computer-readable mediums tangibly encoding a computer program operable to cause data processing apparatus to perform operations), including: triggering an execution of objects through packages using parallel threads at an execution engine, wherein each package of a first set of packages defined for the execution includes a pre-defined number of objects; determining to adjust the pre-defined number of objects per package as defined for the first set of packages at the parallel threads to an adjusted number of objects per package to define a second set of packages; and adjusting the execution at the parallel threads to execute the second set of packages through the execution engine, wherein each package of the second set of packages includes the adjusted number of objects.

In a second general aspect, this specification can be embodied in one or more methods (and also one or more non-transitory computer-readable mediums tangibly encoding a computer program operable to cause data processing apparatus to perform operations), including: receiving a request for executing a test over a project, the project comprising a plurality of objects comprising source code units; obtaining a configuration for parallelized execution of packages in stages at a plurality of threads running at the testing framework, where each stage of the stages is associated with a different number of objects included in a respective number of packages defined per stage, wherein the packages are executed sequentially and in parallel over the plurality of threads; and triggering the parallelized execution of the packages based on the configuration.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example architecture for managing the reuse of sessions in different browsing contexts, according to an implementation of the present disclosure.

FIG. 2 is a flowchart illustrating an example of a computer-implemented method for dynamic parallel execution of operations, according to an implementation of the present disclosure.

FIG. 3 is a flowchart illustrating an example of a computer-implemented method for monitoring parallel execution of operations to generate a configuration for optimized dynamic execution of a test over a project comprising objects including source code, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes mechanisms to implement a dynamic parallel execution of operations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

In software development, before a new source code is activated (e.g., for a new feature), the code is tested (or checked). The source code check can include syntax checks and other validation operations to verify the quality of the software product. In a cloud-based software development context, a development lifecycle can include the execution of code checks (e.g., static code checks) to test the functionality and product standard compliance of a software product/solution. In some instances, the performance of the checks can include not only static checks for newly generated code line (e.g., new or changed code) but also other source code that was pre-existing so that the entire project is analyzed and the quality of the project is determined.

In some instances, performing tests on software projects can be a time-consuming task. Over time, new versions of the software projects can be generated, where some portion of the project may stay without changes while other portions can be changed, or additional portions of code can be added. During the iterative version generation of a software project, tests can be executed over sets of objects including source code. In some cases, the new version can have a portion of objects that overlap with objects part of a previous version. As such, test execution of a subsequent version of a project can be at least partially estimated based on previous executions of a previous version of the project.

In cloud development lifecycles, software projects have high delivery frequency. In some cases, feature-based incremental changes are provided to customers in productive more rather than aggregated over long cycles, for example, as in on-premises software development lifecycles. In those cases, software projects should be processed faster through the phases of a lifecycle pipeline. In a cloud development lifecycle execution, the speed of execution of actions (e.g., time to perform a given tasks (e.g., a test, code check, etc.)) is a key parameter. In some instances, the speed of execution relates to the utilization of hardware resources (e.g., memory, processing units, storage space, etc.). In some instance, the execution of operations can be optimized by execution in parallel over multiple parallel threads, where objects of a software project can be combined in packaged and distributed for execution through the threads. In some cases, objects that are part of a project and can be executed through parallel threads can be associated with different time for execution. In some cases, one object can be processed for ten, twenty, or even a hundred times more time than another object. Thus, when objects are combined in packages, in some cases, a package can include a lot of long-running objects or a lot of short-running objects. In some cases, if a package including a lot of long-running objects is selected to be executed at the latest portion of packages executed through the threads (e.g., within a threshold last packaged at the end of the execution), the overall execution time can be relatively higher compared to an execution time of the same project in the case where long-executing objects are selected for execution at the beginning of the execution. In some cases, if each package executed at a thread of multiple parallel treads includes only a single object, there can be still an overhead of time compared to an optimal execution for such a project. For example, single packages can create higher overhead for single processing, especially, if the last dispatched object is a long-running object. In some instances, the performance of the execution can be compared to a threshold value above which the execution time can be considered “unacceptable” (i.e., above a threshold of what is expected for the execution time).

In accordance with the present implementations, a method for dynamic random parallelization of operations at multiple threads can be configured. In some instances, multiple objects can be started by distributing them to packages of larger package size (e.g., each package including a predefined number of objects (e.g., source code units)), where over time, the objects distributed to packages can be adjusted to a higher or a lower number to dynamically modify the distribution of objects to packages over time. In some instances, the number of objects per package can be considered as a parameter of the configuration of the execution of operations over the objects, which can be dynamically selected. The selection of the numbers of objects per package over time can be performed based on a user provided configuration defining rules for adjusting a size of a package. For example, a first half of the objects can be configured to be executed through packages of one, whereas after the first half of the objects, a fourth of the objects can be configured to be executed through packages including two objects each, and the last fourth of the objects can be configured to be executed through packages including four objects each. In this example, one, two, and four can be considered the values of the number parameter that can be provided by a user or can be empirically determined as an optimized parameter for a given project.

In some instances, the determination of the numbers of objects per package over time can leverage historical run data. In some cases, objects that have been identified to be associated with long execution time (e.g., above a threshold period of time), can be determined to be objects included in the first set of packages pushed to run through parallel threads, where packaged of the first set of packages can have a lower package size, e.g., a fixed predefined size below a threshold value (e.g., one or two objects per package), compared to the package size of subsequent packages.

In some instances, an execution engine can be used to perform tasks in parallelized mode over multiple threads. In some instances, the execution engine can be configured to execute checks or tests of projects including objects of source code according to a configuration. In some instances, the configuration can define a schedule for running objects in packages over the multiple threads.

In some instances, a project can be defined as a high-level entity relevant for executing a test. In some instances, the test execution can be performed in phases, where each phase can be associated with different tasks. In some instances, each phase can have one or more execution units that are executed sequentially. Each execution unit can spawn one or more proxies to which the execution can be delegated. Each proxy spawns a client (or a client process) that can be designated for the execution of a package. Each client can execute operations associated with a given execution unit. In some instances, parallel execution of tasks at multiple threads can be performed by each execution unit.

In some instances, when a project including source code is to be tested to analyze the source code's quality, individual processes can be created, and work bundles can be distributed to each process. In some instances, packages can be defined for executing operations, such as performing operations over objects including source code. If parallelization is to be used, simply distributing tests (or checks) tasks for a single object per thread of multiple threads may not lead to an optimal distribution of the tasks. In accordance with the present application, bundles or packages include a set of objects to be processed (checked, tested, validated, etc.) in a particular sequence that can reduce the required time for the overall execution. For example, such parallelization can occur when there is a number of heterogeneous (with respect to time period needed for execution) tasks to be performed with a number of parallel processes and there is a non-negligible overhead in time to the inter-process communication and sequence of execution.

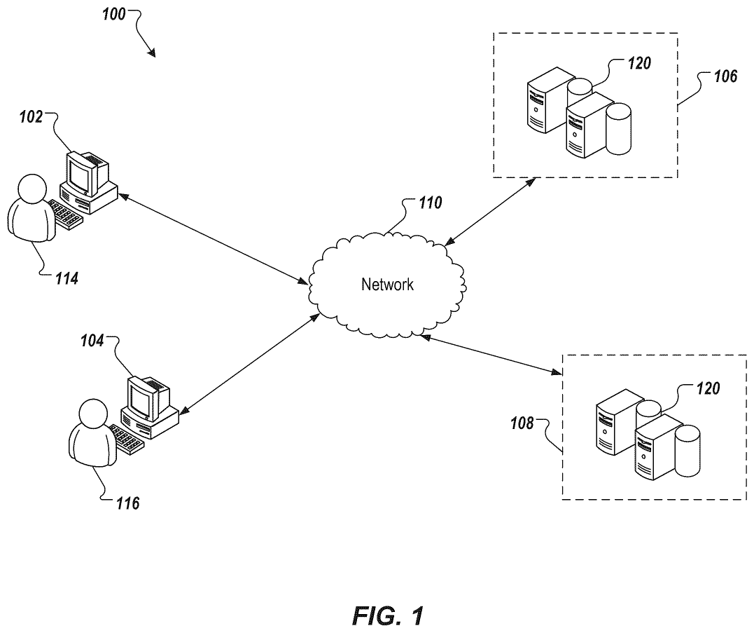

FIG. 1 depicts an example architecture 100 for managing reuse of sessions in different browsing contexts, according to an implementation of the present disclosure.

In the depicted example, the example architecture 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provide such services to any number of client devices (e.g., the client device 102 over the network 110) and other service requests, as appropriate.

In some instances, the environments 106 and 108 may host one or more client applications, application servers, and authorization servers to support the execution of secure requests between the client applications and the application server. In some instances, the users 114 or 116 may access a client application through the network 110. The client application may be communicatively coupled with an application server. The application server may include application logic implemented to provide services and resources to end users. In some instances, the environments 106 and 108 may host execution engines for processing tasks, for example, as part of a testing framework.

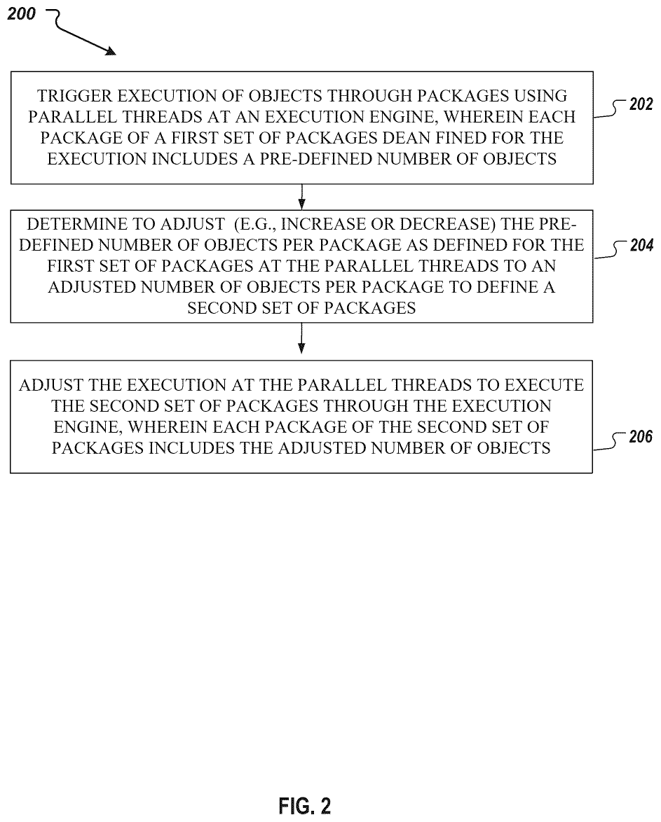

FIG. 2 is a flowchart illustrating an example of a computer-implemented method 200 for dynamic parallel execution of operations, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

In some instances, objects that include source code units, for example, stored at a source code repository, can be part of a project that is tested. The project can be generated in versions and objects of the projects can change over time, where some objects can remain the same, some can be adjusted (modified or expanded), some can be removed, and some can be newly added. The execution of tests of the whole process can be performed iteratively, and for example, at a predefined schedule. For example, when a new version of the project is submitted in the source code repository, a test process can be triggered. In some instances, for executing a given test for a project, objects can be provided for parallel execution through parallel threads as described in relation to the method 200.

At 202, an execution of objects is triggered through packages using parallel threads at an execution engine. In some instances, each package of the first set of packages defined for the execution includes a pre-defined number of objects. For example, objects associated with execution time above a threshold value can be selected to be executed first through packages that include a single object.

At 204, a determination is made to adjust the pre-defined number of objects per package as defined for the first set of packages at the parallel threads. The adjustment can be done so that a second set of packages to be executed includes an adjusted number of objects per package. For example, if the initial set of packages that are executed includes one object per package, the second set of packages can include two objects per package, four objects per package, or other.

At 206, the execution at the parallel threads can be adjusted to execute the second set of packages through the execution engine. Each package of the second set of packages includes the adjusted number of objects.

In some instances, the execution of the objects through the first set of packages can be monitored. For example, based on the monitoring, it can be determined to adjust the pre-defined number of objects. For example, the adjusted number can be determined when a threshold number of objects are executed, or after a threshold period of time of execution, or another predefined configuration.

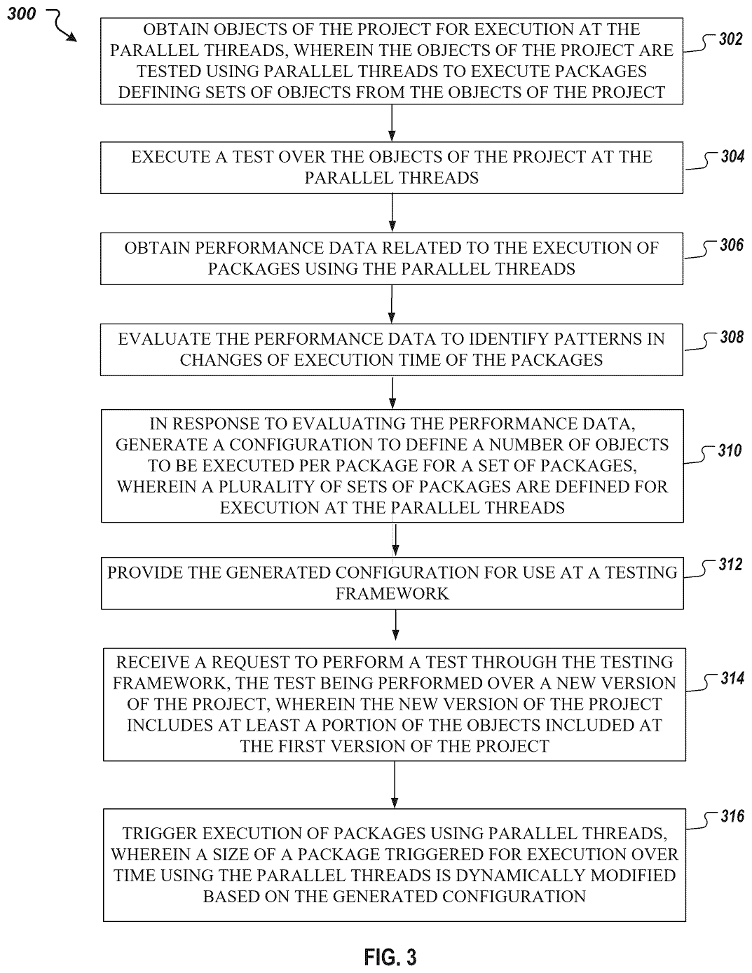

FIG. 3 is a flowchart illustrating an example of a computer-implemented method 300 for monitoring parallel execution of operations to generate a configuration for optimized dynamic execution of a test over a project comprising objects including source code, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, objects of a project can be obtained for execution at the parallel threads. In some instances, the objects can be obtained for execution of the objects through packages using parallel threads, for example, as described in relation to method 200 of FIG. 2. In some instances, the objects of the project can be obtained for performing a testing of the project. The objects can be tested using the parallel threads where packages are executed. In some instances, the packages can define a set of objects from the objects of the project to be executed together. In some instances, the packages can be executed consecutively through the various threads. In some instances, the objects obtained at 302 can be obtained from a source code repository. In some instances, the objects can be associated with a given version of the project.

At 304, a test over the objects of the project can be executed at the parallel threads. The parallel threads can be defined at an execution engine, for example, as part of a testing framework.

At 306, the execution of the first set of packages at the parallel threads can be monitored.

At 308, performance data related to the execution of the packages at the parallel threads can be obtained. In some instances, the packages can be executed with different size and in stages, where each stage corresponds to a different size of the package. In some instances, the execution of the packages and the objects in the packages can be evaluated from the perspective of the required time for the objects' execution. The performance data can be evaluated to identify patterns in changes of the execution time of the packages.

At 310, in response to evaluating the performance data, a configuration defining a the number of objects to be executed per package for a set of packages over the stages can be generated. In some instances, a plurality of sets of packages can be defined for execution at the parallel threads. A number of objects per package is associated with each respective set of the plurality of sets of packages. As such, at each stage associated with a given number of objects per package, a set of packages are executed through the multiple parallel threads. The plurality of sets of packages can be executed in a sequence using the parallel threads. In some instances, the packages can be ordered to include objects that are associated with longer execution time (e.g., above a threshold value) as part of the first set of packages to be executed at the first stage of the sequential execution, and subsequent packages can be also staged and defined to be associated with different numbers of objects per package.

In some instances, the number of objects per package per set from the plurality of sets can be defined in an increasing order of the sequence, in a decreasing order, or in a particular pattern that is determined based on the evaluation of the performance data.

At 312, providing the generated configuration can be provided for use at a testing framework. In some instances, during the execution at the testing framework, the objects can be checked, for example, source code checks can be performed. Since the configuration is generated based on a monitored execution of objects through packages (e.g., as described in relation to operation 304 of FIG. 3 or as described in relation to FIG. 2), the configuration is generated based on historical data associated with the given project for which a test is executed. In some instances, the historical data that is used to generate the configuration is related to the first version of the project, and the configuration can be applied when a subsequent version of the project is tested. In some instances, the subsequent version of the project can include an overlap of the objects that have not been modified in the subsequent version and substantially correspond to those of the first version. The use of the information for their previous execution can be used to navigate the execution of subsequent tests. For example, the historical data can indicate which are the objects that are associated with the longest execution time and/or which are the objects associated with failure during their execution. Such information can be leveraged to predict the expected execution times of objects associated with a subsequent (or new) version of the project. Thus, the configuration that is based on such prediction can optimize the execution of the test over the subsequent version of the project.

At 314, a request to perform a test through the testing framework is received. The test is requested to be performed over a new version of the project. The new version of the project includes at least a portion of the objects included at the first version of the project.

At 316, execution of packages using parallel threads (e.g., at the execution engine of the testing framework) can be triggered. A size of a package triggered for execution over time using the parallel threads can be dynamically modified based on the generated configuration.

In some implementations, the execution of tests at a testing framework can be scheduled according to a scheduling scheme that can be defined to reduce the runtime execution and to reduce the resource expenditures for performing the tests. The execution of tests and the execution time of particular tasks, e.g., processing objects, in a project as described in relation to FIGS. 2 and 3 can be monitored and performance data can be evaluated to determine optimizations for the execution and distribution of the load through packages of different size that can run in parallel mode. In some cases, if it is observed that the processing time of the latest packages take relatively longer compared to the other executions of previous packages, it can be considered whether longer running objects were those that were scheduled at the end. In some instances, in those cases, the scheduling of objects of a project for their execution can take into consideration the execution time per object, so that objects that are associated with longer execution time can be scheduled to be executed first for a subsequent execution of a test object the present version of the project, or a new or updated version of the project. The scheduling of the execution of objects in packages can use information from a previous execution to provide an estimate for object executions for a new request for execution and utilize an optimized configuration.

In some instances, a naïve approach to schedule object execution in multiple parallel threads to reduce the runtime and resource expenditures can be considered to run series (or stages as previously mentioned) of packages, where at each stage a different number of objects are included in a package. The definition of the number of objects per package and per stage can be based on analyzing performance data for previous or recent execution of the same series (e.g., for the same project or for a previous version of the project) for which processing times data is still available. In some instances, the processing time of previously executed operations can be stored and provided for data evaluation to facilitate the configuration of execution of objects as described in the present disclosure. In some instances, based on historical data, it can be determined to perform longest-processing-time-first scheduling (LPTF). By using such scheduling, the time for the execution can be lower compared to executing the objects in a random manner.

In some instances, using fixed size packages for execution for several stages of execution can be associated with longer processing time when the average time for executing objects of the project is above a threshold value, or when a percentage above a threshold value of the objects of the project are associated with execution time that can be used to categorize them as long-running objects (e.g., a range defined for the time period).

The LPTF scheduling can be applied to the distribution of the package over threads, however, in cases where a package includes a lot of running objects, e.g., 50 objects, 60 objects, or another predefined value (that can be empirically determined or user selected), the package that includes so many object can run through a substantial portion of the time for the whole entire execution, so that the other packages can be executed even prior to the execution of such a package. As such, configuring packages size can be defined based on considerations of the distribution of execution times per objects from the project so that the size of the packages per stage can support the improvement of the overall execution time. In some examples according to the LPTF scheduling, an algorithm for the execution of packages can be defined to follow a configuration where one package can be defined to include objects that run above a first threshold time period (e.g., can be categorized as longest-running objects) and to include objects that are below another second threshold period (e.g., can be categorized as shortest-running objects) in a package so that the package size is reached or so that a timeout threshold for processing time is reached (e.g., 90 minutes of processing time, or within a range/tolerance around 80 or 90 minutes). In this example, the two packages can be defined with the same size corresponding to the expected time for execution but with a different number of objects included per package. In some instances, the configuration can define to proceed with grouping remaining objects part of the project into packages so that the objects are distributed based on their expected execution time and within packages of relatively similar size (e.g., associated with an expected execution time that is within the timeout threshold as described in relation to the shortest and longest running objects). However, such an approach can be associated with cases where the packages at the end of the processing still have long processing times compared to the case where they would only include shortest-running objects, and decreasing the package size can increase the overhead of inter-processing communication above an acceptable threshold.

In accordance with implementations of the present disclosure, an algorithm for executing objects in parallel threads to minimize runtime can be defined to dynamically adapt the package size. In some instances, the longest-running objects (e.g., categorized as such based on a criterion or when above a define threshold value) can be scheduled for execution first as single objects per package, and then build small packages for a next stage, where the next-longest-running objects can be executed. Further, larger packages (e.g., according to an empirically determined size, predefined, user provided, or based on input from another system, among other examples) can be defined for the shortest objects. Such staging of execution of sets of packages, where each stage is associated with objects of a different category related to their execution time (e.g., one or more of categories such as longest-running, next-longest-running, average-running, short-running, shortest running, etc.) can reduce the overhead of executed calls for processing the objects since the longest running objects can be scheduled at the start while few packages with very short objects can be executed while still waiting for the execution of the longest.

In some instances, new objects not previously part of an execution (e.g., and not part of the historic data) and failed objects can be distributed into packages at the beginning with package size 1. In some instances, the size of the package can be increased, for example, quadratically. If the number of packages after which the size should be increased is 100 (e.g., in a case where there can be 100 packages including 100 objects, one object per package), then the next set of objects to be included in a package can be set to two (2), then the next set of objects to be included into a package can be set to four (4), and so forth. As such, the initial 100 packages would include one object each, and thus, 100 objects altogether, and for a second stage, the 100 packages would include 2 objects each and thus, 200 objects altogether, and for the third stage, there would be 100 packages including 4 objects each and 400 altogether. The definition of the number of packages after which a change of the number of objects to be included in a package can be set as part of the configuration for the execution. Such numbers can be determined based on evaluating the number of objects in the project and their time for execution as monitored and evaluated, for example, as described in relation to FIG. 3

In some instances, such an approach for scheduling objects into packages to be executed at multiple parallel threads can be simulated, for example, based on an existing project to determine a percentage of the deviation of a theoretically optimal runtime. In some instances, based on evaluating the deviation to be below an acceptable deviation value, the configuration can be accepted and provided for use by a testing framework. Such an approach can improve the performance of the execution of projects including tasks with heterogeneous runtimes and significant (compared to the average runtime of the smallest tasks) inter-process communication overhead that needs to be processed as quickly as possible, and where the runtime of the tasks is predictable, either deterministically or using heuristics.

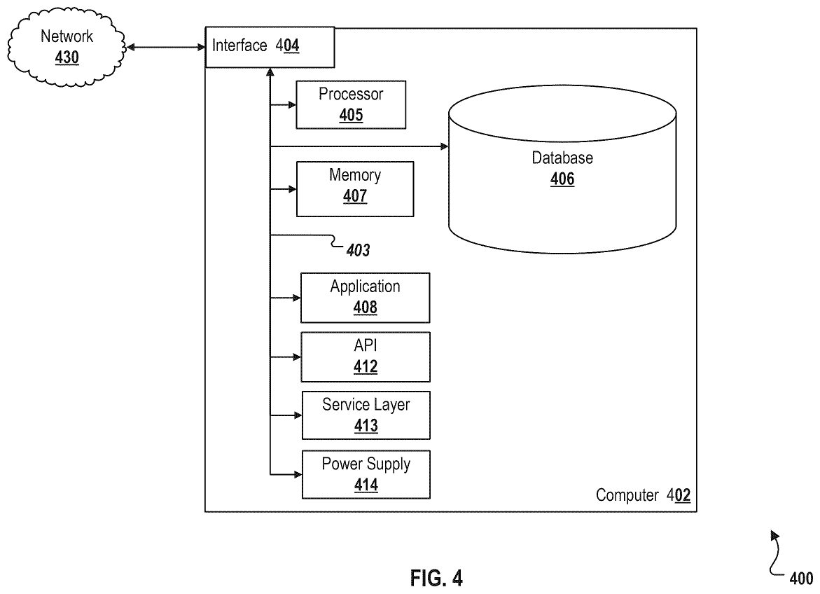

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over the Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 404 that can hold data for the Computer 402, another component communicatively linked to the Network 430 (whether illustrated or not), or a combination of the Computer 402 and another component. For example, Database 404 can be an in-memory or conventional database storing data consistent with the present disclosure. In some implementations, Database 404 can be a combination of two or more different database types (for example, a hybrid in-memory and conventional database) according to particular needs, desires, or particular implementations of the Computer 402 and the described functionality. Although illustrated as a single Database 404, two or more databases of similar or differing types can be used according to particular needs, desires, or particular implementations of the Computer 402 and the described functionality. While Database 404 is illustrated as an integral component of the Computer 402, in alternative implementations, Database 404 can be external to the Computer 402. The Database 404 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### EXAMPLES

Although the present application is defined in the attached claims, it should be understood that the present invention can also be (alternatively) defined in accordance with the following examples:

Example 1: A computer-implemented method for dynamic parallel execution of operations, comprising:
triggering an execution of objects through packages using parallel threads at an execution engine, wherein each package of a first set of packages defined for the execution includes a pre-defined number of objects;
determining to adjust the pre-defined number of objects per package as defined for the first set of packages at the parallel threads to an adjusted number of objects per package to define a second set of packages; and
adjusting the execution at the parallel threads to execute the second set of packages through the execution engine, wherein each package of the second set of packages includes the adjusted number of objects.

Example 2: The computer-implemented method of Example 1, comprising:
defining a project comprising the objects to be tested, wherein an object of the objects represents a source code unit at a source code repository; and
providing the objects of the project for execution at the parallel threads, wherein the objects of the project are tested during the execution of the first set of packages and the second set of packages.

Example 3: The computer-implemented method of Example 1 or Example 2, wherein determining to adjust the pre-defined number of objects is performed when a threshold number of packages including the pre-defined number of objects have been successfully executed using the parallel threads.

Example 4: The computer-implemented method of any one of the preceding Examples, wherein determining to adjust the pre-defined number of objects per package comprises:
monitoring execution of the first set of packages at the parallel threads.

Example 5: The computer-implemented method of any one of the preceding Examples, comprising:
obtaining performance data related to the execution of the first set of packages and the second set of packages using the parallel threads; and
evaluating the performance data to identify patterns in changes of execution time of the packages.

Example 6: The computer-implemented method of Example 5, comprising:
in response to evaluating the performance data, generating a configuration to define a number of objects to be executed per package for a set of packages, wherein a plurality of sets of packages are defined for execution at the parallel threads, and wherein a number of objects per package is associated with each respective set of the plurality of sets of packages, wherein the plurality of sets of packages are executed in a sequence using the parallel threads.

Example 7: The computer-implemented method of Example 6, wherein each set of the plurality of sets of packages in the sequence is associated with a respective number of objects per package, wherein numbers of objects per package per set for the plurality of sets are defined in an increasing order of the sequence.

Example 8: The computer-implemented method of Example 6 or Example 7, comprising:
providing the generated configuration for use at a testing framework.

Example 9: The computer-implemented method of Example 8, wherein the objects checked during the execution of the first set of packages and the second set of packages are part of a first version of a project defined for a software solution, and comprising:
receiving a request to perform a test through the testing framework, the test being performed over a new version of the project, wherein the new version of the project includes at least a portion of the objects included at the first version of the project; and
triggering execution of packages using parallel threads at an execution engine, wherein a size of a package triggered for execution over time using the parallel threads is dynamically modified based on the generated configuration.

Example 10: A computer-implemented method for dynamic execution of operations at parallel threads at a testing framework, the method comprising:
receiving a request for executing a test over a project, the project comprising a plurality of objects comprising source code units;
obtaining a configuration for parallelized execution of packages in stages at a plurality of threads running at the testing framework, where each stage of the stages is associated with a different number of objects included in respective number of packages defined per stage, wherein the packages are executed sequentially and in parallel over the plurality of threads; and
triggering the parallelized execution of the packages based on the configuration.

Example 11: A non-transitory, computer-readable medium storing one or more instructions executable by a computer system to perform operations according to any one of the methods according to Examples 1 to 10.

Example 12: A computer-implemented system, comprising:
one or more computers; and
one or more computer memory devices interoperably coupled with the one or more computers and having tangible, non-transitory, machine-readable media storing one or more instructions that, when executed by the one or more computers, perform operations according to any one of the methods according to Examples 1 to 10.

What is claimed is:

1. A computer-implemented method for dynamic parallel execution of operations, comprising:
triggering an execution of objects through packages using parallel threads at an execution engine, wherein each package of a first set of packages defined for the execution includes a pre-defined number of objects;
determining to adjust the pre-defined number of objects per package as defined for the first set of packages at the parallel threads to an adjusted number of objects per package to define a second set of packages; and
adjusting the execution at the parallel threads to execute the second set of packages through the execution engine, wherein each package of the second set of packages includes the adjusted number of objects.

2. The computer-implemented method of claim 1, comprising:
defining a project comprising the objects to be tested, wherein an object of the objects represents a source code unit at a source code repository; and
providing the objects of the project for execution at the parallel threads, wherein the objects of the project are tested during the execution of the first set of packages and the second set of packages.

3. The computer-implemented method of claim 1, wherein determining to adjust the pre-defined number of objects is performed when a threshold number of packages including the pre-defined number of objects have been successfully executed using the parallel threads.

4. The computer-implemented method of claim 1, wherein determining to adjust the pre-defined number of objects per package comprises:
monitoring execution of the first set of packages at the parallel threads.

5. The computer-implemented method of claim 1, comprising:
obtaining performance data related to the execution of the first set of packages and the second set of packages using the parallel threads; and
evaluating the performance data to identify patterns in changes of execution time of the packages.

6. The computer-implemented method of claim 5, comprising:
in response to evaluating the performance data, generating a configuration to define a number of objects to be executed per package for a set of packages, wherein a plurality of sets of packages are defined for execution at the parallel threads, and wherein a number of objects per package is associated with each respective set of the plurality of sets of packages, wherein the plurality of sets of packages are executed in a sequence using the parallel threads.

7. The computer-implemented method of claim 6, wherein each set of the plurality of sets of packages in the sequence is associated with a respective number of objects per package, wherein numbers of objects per package per set for the plurality of sets are defined in an increasing order of the sequence.

8. The computer-implemented method of claim 6, comprising:
providing the generated configuration for use at a testing framework.

9. The computer-implemented method of claim 8, wherein the objects checked during the execution of the first set of packages and the second set of packages are part of a first version of a project defined for a software solution, and comprising:
receiving a request to perform a test through the testing framework, the test being performed over a new version of the project, wherein the new version of the project includes at least a portion of the objects included at the first version of the project; and
triggering execution of packages using parallel threads at an execution engine, wherein a size of a package triggered for execution over time using the parallel threads is dynamically modified based on the generated configuration.

10. A non-transitory, computer-readable medium storing one or more instructions executable by a computer system to perform operations comprising:
triggering an execution of objects through packages using parallel threads at an execution engine, wherein each package of a first set of packages defined for the execution includes a pre-defined number of objects;
determining to adjust the pre-defined number of objects per package as defined for the first set of packages at the parallel threads to an adjusted number of objects per package to define a second set of packages; and
adjusting the execution at the parallel threads to execute the second set of packages through the execution engine, wherein each package of the second set of packages includes the adjusted number of objects.

11. The non-transitory, computer-readable medium of claim 10, further storing instructions executable by the computer system to perform operations comprising:
defining a project comprising the objects to be tested, wherein an object of the objects represents a source code unit at a source code repository; and
providing the objects of the project for execution at the parallel threads, wherein the objects of the project are tested during the execution of the first set of packages and the second set of packages.

12. The non-transitory, computer-readable medium of claim 10, wherein determining to adjust the pre-defined number of objects is performed when a threshold number of packages including the pre-defined number of objects have been successfully executed using the parallel threads.

13. The non-transitory, computer-readable medium of claim 10, wherein determining to adjust the pre-defined number of objects per package comprises:
monitoring execution of the first set of packages at the parallel threads.

14. The non-transitory, computer-readable medium of claim 10, further storing instructions executable by the computer system to perform operations comprising:
obtaining performance data related to the execution of the first set of packages and the second set of packages using the parallel threads; and
evaluating the performance data to identify patterns in changes of execution time of the packages.

15. The non-transitory, computer-readable medium of claim 14, further storing instructions executable by the computer system to perform operations comprising:
in response to evaluating the performance data, generating a configuration to define a number of objects to be executed per package for a set of packages, wherein a plurality of sets of packages are defined for execution at the parallel threads, and wherein a number of objects per package is associated with each respective set of the plurality of sets of packages, wherein the plurality of sets of packages are executed in a sequence using the parallel threads.

16. The non-transitory, computer-readable medium of claim 15, wherein each set of the plurality of sets of packages in the sequence is associated with a respective number of objects per package, wherein numbers of objects per package per set for the plurality of sets are defined in an increasing order of the sequence.

17. The non-transitory, computer-readable medium of claim 15, comprising:
providing the generated configuration for use at a testing framework.

18. The non-transitory, computer-readable medium of claim 17, wherein the objects checked during the execution of the first set of packages and the second set of packages are part of a first version of a project defined for a software solution, and further storing instructions executable by the computer system to perform operations comprising:
receiving a request to perform a test through the testing framework, the test being performed over a new version of the project, wherein the new version of the project includes at least a portion of the objects included at the first version of the project; and
triggering execution of packages using parallel threads at an execution engine, wherein a size of a package triggered for execution over time using the parallel threads is dynamically modified based on the generated configuration.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
triggering an execution of objects through packages using parallel threads at an execution engine, wherein each package of a first set of packages defined for the execution includes a pre-defined number of objects;
determining to adjust the pre-defined number of objects per package as defined for the first set of packages at the parallel threads to an adjusted number of objects per package to define a second set of packages; and
adjusting the execution at the parallel threads to execute the second set of packages through the execution engine, wherein each package of the second set of packages includes the adjusted number of objects.

20. The computer-implemented system of claim 19, wherein the non-transitory, machine-readable media stores further instructions that, when executed by the one or more computers, perform operations comprising:
defining a project comprising the objects to be tested, wherein an object of the objects represents a source code unit at a source code repository; and
providing the objects of the project for execution at the parallel threads, wherein the objects of the project are tested during the execution of the first set of packages and the second set of packages.
